(19) United States
(12) Patent Application Publication
(10) Pub. No.: US 2007/0092392 A1
(43) Pub. Date: Apr. 26, 2007

(54) Internal gear pump

(75) Inventor: Hiroyuki Kurokawa, Aichi-gun (JP)

Correspondence Address: REED SMITH LLP, 3110 Fairview Park Drive, Suite 1400, Falls Church, VA, 22042, US

(73) Assignee: Aisin Seiki Kabushiki Kaisha

(21) Appl. No.: 11/582,344

(22) Filed: Oct. 18, 2006

(30) Foreign Application Priority Data
Oct. 20, 2005 (JP) 2005-305646

(51) Int. Cl. F01C 1/02; F16N 13/20; F01C 1/063

(52) U.S. Cl. 418/61.3

(57) ABSTRACT

An internal gear pump includes a recessed portion communicating with each corresponding interproximal space and defined in a way that the inlet port and the outlet port are prevented from communicating with each corresponding interproximal space at the position where each corresponding interproximal space attains the maximum volume. The recessed portion opens in a direction between a radial direction of the one of the driving rotor and the driven rotor and a circumferential direction thereof at each tooth of the one of the driving rotor and the driven rotor.

### CROSS REFERENCE TO RELATED APPLICATIONS

This application is based on and claims priority under 35 U.S.C § 119 with respect to Japanese Patent Application 2005-305646, filed on Oct. 20, 2005, the entire content of which is incorporated herein by reference.

### FIELD OF THE INVENTION

The present invention relates to an internal gear pump. More particularly, the present invention relates to an internal gear pump having a rotor structure, which prevents the occurrence of cavitations.

### BACKGROUND

Generally, when known internal gear pumps, which are broadly employed in vehicle oil pumps, rotate at a high revolution and the intake flow rate is increased to exceed the pump suction rate due to resistance of viscosity, the pump induces cavitation within a suction passage (an inlet port and an interproximal space). The occurrence of cavitation leads to various matters such as a loss of volumetric efficiency, unusual noise and erosion occurring within the pump.

One of the solutions for the matters, as disclosed in JP 9 (1997)-296716A, would be to use a pump which has a groove or a chamfer on a side face of a driving rotor in communication with an interproximal space. In a condition where the groove or chamber communicates with an adjacent interproximal space, a rapid pressure fluctuation is relieved to prevent cavitation. According to the aforementioned structure of pump, it is expected to control the amount of cavitation to some extent, however, no effect is shown for an excessive acceleration of the intake flow which is a basic factor of the occurrence of cavitation. For this reason, a significant improvement is not accomplished.

Also, as disclosed in JP6 (1994)-117379A, there is a pump having a groove which is provided on a side face of a driving rotor or a driven rotor and opens in a rotational direction. However, the rotor structure is meant to reduce contact resistance between a rotor and a pump chamber by injecting a fluid into a clearance between the sidewall of the rotor chamber and one of the driving rotor or the driven rotor. Therefore, there is no positive effect in the prevention for cavitation occurred in interproximal spaces.

Meanwhile, as disclosed in JP 7 (1995)-102928A, known is a pump which has a groove on a front side portion of either a driving rotor or a driven rotor in a rotational direction. The groove communicates with a pump chamber prior to an outlet port avoiding oil reflex from the outlet port to the high-pressure pump chamber to prevent water hammering. However, in this structure, it is expected to surpass water hammering which occurs during discharging oil, however, the structure has no effect in an excessive acceleration of intake flow, which is a basic factor of the occurrence of cavitation.

Further, there is a kind of pump which is provided with recessed portions which are formed at a tooth bottom portion of the driving rotor and open radially outwardly, to prevent cavitation occurring in suction. (For example, refer to DE 102 45 814 B3) However, in this structure, a sealing portion is required between the recessed portions arranged in the tooth bottom portion and a center hole. Thus, the driving rotor needs a larger diameter resulting in an enlargement of the oil pump and an increase in friction. The present invention has been made in view of the above circumstances, and provides an internal gear pump in which an occurrence of cavitation between interproximal spaces of rotors are prevented and a size of the pump is restrained.

### SUMMARY OF THE INVENTION

According to an aspect of the present invention, an internal gear pump includes a housing forming a cylindrical space; a driven rotor having internal teeth and rotatably disposed in the cylindrical space; a driving rotor having external teeth engageable with the internal teeth and rotatably disposed in the driven rotor. The driving rotor and the driven rotor defines a plurality of interproximal spaces therebetween, the interproximal spaces repeatedly expanding and shrinking between the internal teeth of the driven rotor and the external teeth of the driving rotor engaged with the internal teeth so that fluid is suctioned and discharged. The internal gear pump further includes an inlet port formed at the housing in communication with the cylindrical space; an outlet port formed at the housing in communication with the cylindrical space; a recessed portion provided at at least one side surface of at least one of the driven rotor and the driving rotor. The recessed portion communicates with each corresponding interproximnal space and defined in a way that the inlet port and the outlet port are prevented from communicating with each corresponding interproximal space at the position where each corresponding interproximal space attains the maximum volume, and the recessed portion opening in a direction between a radial direction of the one of the driving rotor and the driven rotor and a circumferential direction thereof at each tooth of the one of the driving rotor and the driven rotor.

### BRIEF DESCRIPTION OF THE DRAWINGS

The foregoing and additional features and characteristics of the present invention will become more apparent from the following detailed description considered with reference to the accompanying drawings, wherein:

FIG. 1 is a back side view of the pump 100 according to an embodiment of this invention;

FIG. 2 is a view illustrating an engagement between a driving rotor 50 and a driven rotor 40;

FIG. 3 is a cross sectional view taken along a line III-III of FIG. 2;

FIG. 4 is a cross sectional view taken along a line IV-IV of FIG. 2;

FIG. 5 is a cross sectional view illustrating a main portion of a relationship between the driven rotor 40 and the driving rotor 50 and an inlet port 12 according to the embodiment of this invention;

FIG. 6 is a cross sectional view illustrating the main portion of the relationship between the driven rotor 40 and the driving rotor 50 and an inlet port 12 according to a known pump;

FIG. 7 is a cross sectional view of recessed portions 550 and recessed portions 450 according to another embodiment of the invention;

FIG. 8 is a comparison of pump volumetric efficiency between the pump with a recessed portions 55 and the one without the recessed portions 55;

FIG. 9 is a comparison of driving power between the pump with the recessed portions 55 and the one without the recessed portions 55;

FIG. 10 is an engagement view when the recessed portions 55 are formed on one side of the driven rotor 40 and the driving rotor 50;

FIG. 11 is another engagement view when the recessed portions 55 are formed on one sides of the driven rotor 40 and the driving rotor 50;

FIG. 12 is another engagement view when the recessed portions 55 are formed on one sides of the driven rotor 40 and the driving rotor 50;

FIG. 13 is another engagement view when the recessed portions 55 are formed on one sides of the driven rotor 40 and the driving rotor 50; and

FIG. 14 is an engagement view illustrating a variation of a shape of the recessed portions illustrated in FIG. 10

### DETAILED DESCRIPTION

An embodiment of the present invention will be described below with reference to the attached drawings.

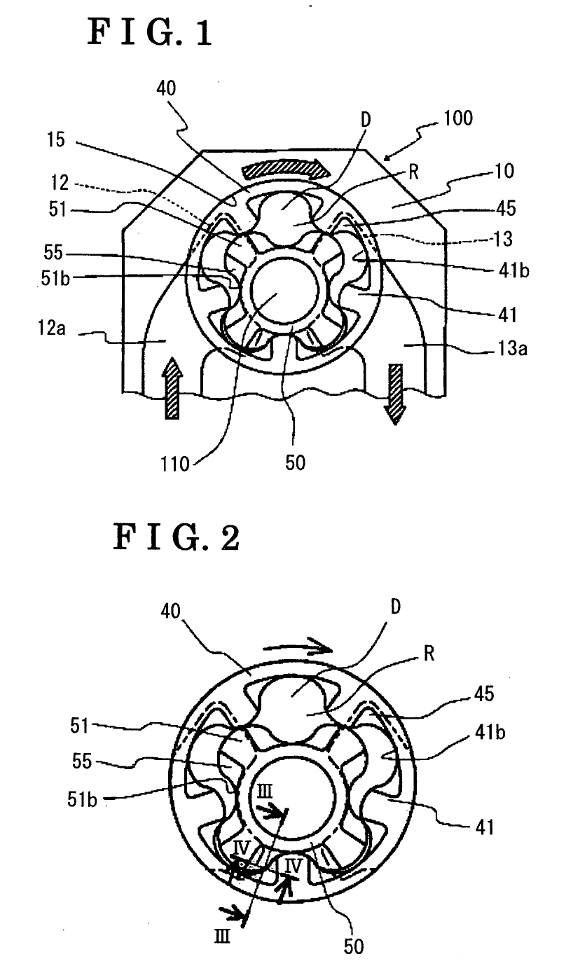

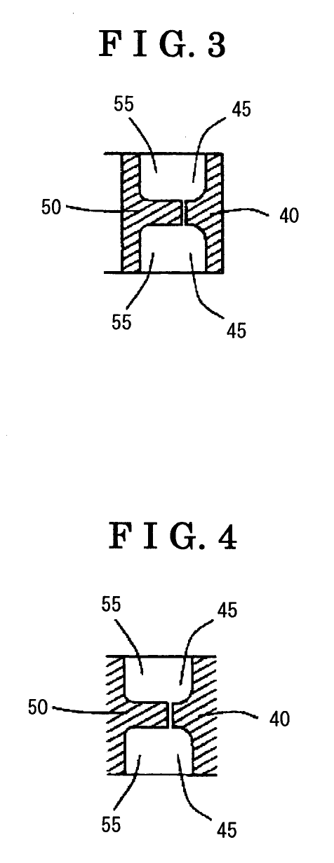

FIG. 1 is a back side view of a pump (internal gear pump) 100. The pump 100 includes; a body 10, a cover which is not illustrated, a driven rotor 40, a driving rotor 50, a shaft 110 which is rotatably fitted into the center of the driving rotor 50 to operate the driving rotor 50. A housing is constructed by the body 10 and the cover which is not illustrates and a rotor chamber 15, which is a cylindrical space, is defined in the housing, The driving rotor 50, into which the shaft 110 is rotatably fitted, and the driven rotor 40, which is engaged with the driving rotor 50 in an eccentric manner at a predetermined amount, are housed in the rotor chamber 15. The driving rotor 50 is provided with external teeth 51, while the driven rotor 40 is provided with internal teeth 41. The driving rotor 50 is engaged with the driven rotor 40 with the external teeth 51 meshed with the internal teeth 41.

The driving rotor 50 is rotated by a rotational driving force of the shaft 110. The driven rotor 40 is rotated by the engagement or contact with the driving rotor 50. Fluid is suctioned from a suction passage 12a through an inlet port 12 and discharged to a discharge passage 13a through an outlet port 13. The inlet port 12 and the outlet port 13 are defined by the housing, respectively.

Interproximal spaces R are defined between the driving rotor 50 and the driven rotor 40. Forcing on one of the interproximal spaces R, the interproximal space R move the inlet port 12 in a rotational direction in response to the rotation of the driven rotor 40 and the driving rotor 50. While the inlet port 12 is being moved in the rotational direction, the volume of the interproximal space R gradually expands and attains the maximum volume at a closed position D defined between the inlet port 12 and the outlet port 13. Then, the interproximal space R moves from the closed portions D in the rotational direction along the outlet port 13 in response to the rotation of the driven rotor 40 and the driving rotor 50. The volume of the interproximal space R is gradually reduced during the movement. In this way, the pump 100 sucks and discharges the fluid through the inlet port 12 and the outlet port 13 via the interproximal spaces R of which volumes expand and shrink in response to the rotation of the driven rotor 40 and the driving rotor 50.

The driving rotor 50 is provided with recessed portions 55 formed on side faces of each external tooth 51. Each recessed portion 55 opens in a direction between a radial direction of the driving rotor 50 and a circumferential direction thereof at each external tooth 51. The recessed portion 55 also communicates with the corresponding interproximal space R. The recessed portions 55 extend at both sides of the tooth bottom portion 51b of each tooth 51 and are respectively formed in an L shape on the cross section including the axis of the driving rotor 50. The recessed portion 55 can be formed on one side face of each external tooth 51. In this case, the recessed portion 55 has an identical shape as each recessed portion 55 formed at both side faces of each external tooth 51.

Meanwhile, the driven rotor 40 is provided with recessed portions 45 formed on side faces of each internal tooth 41. Each recessed portion 45 opens in a direction between a radial direction of the driven rotor 40 and a circumferential direction thereof at each internal tooth 41. The recessed portion 45 also communicates with the corresponding interproximal space R. The recessed portions 45 extend at both sides of the tooth bottom portion 41b of each tooth 41 and are respectively formed in an L shape on the cross section including the axis line of the driven rotor 40. The recessed portion 45 can be formed one side face of each internal tooth 41. In this case, the recessed portion 45 has an identical shape as each recessed portion 45 formed at both side faces of each internal tooth 41.

Furthermore, the recessed portions 55 of the driving rotor 50 and the recessed portions 45 of the driven rotor 40 are formed in an area where the outlet port 13 and the inlet port 12 do not communicate with the interproximal space R when the interproximal space R is positioned so as to attain the maximum volume. In other words, a circumferential edge of each recessed portion 55 of the driving rotor 50 and a circumferential edge of each recessed portion 45 of the driven rotor 40 approximately lie over or overlap a circumferential edge of a contour of the outlet port 13 and a circumferential edge of a contour of the inlet port 12 in an axial direction of the rotors 40 and 50. Therefore, the fluid can be suctioned from the inlet port 12 and discharged to the outlet port 13 in an efficient manner. Further, in order to suction the fluid via the inlet port 12 efficiently and to discharge via the outlet port 13 efficiently, it is preferable that an opening area of each recessed portion 55 as viewed from a side surface of the driving rotor 50 is approximately identical to an opening area of each recessed portion 55 as viewed from the side of the recessed portion 55 in a direction perpendicular to an axial direction thereof. Likewise, it is preferable that an opening area of each recessed portion 45 as viewed from a side surface of the driven rotor 40 is approximately identical to an opening area of each recessed portion 45 as viewed from the side of the recessed portion 45 in a direction perpendicular to an axial direction thereof.

Alternatively, it is preferable that an axial depth of each recessed portion 55 of the driving rotor 50 is approximately identical to a circumferential length of the recessed portion 55. Likewise, it is preferable that an axial depth of each recessed portion 45 of the driven rotor 40 is approximately identical to a circumferential length of the recessed portion 45.

Still further, by forming the recessed portions 55 and 45 respectively in an L shape, when the driving rotor 50 and the driven rotor 40 are manufactured, in a metal sintering process which is one of manufacturing methods generally employed, the recessed portions 55 and 45 are readily formed. Also, homogeneity of the metallic density is achieved, resulting in the stable quality,

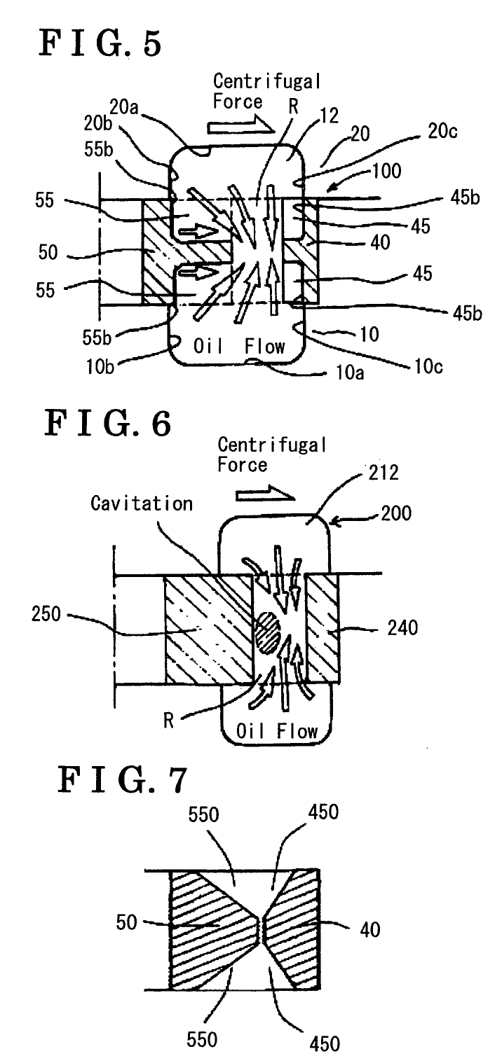

FIG. 5 is a sectional view illustrating a main portion of the relationship of the driven rotor 40 and the driving rotor 50 and the inlet port 12. The inlet port 12 is formed by a recessed portion 10a of the body 10 and a recessed portion 20a of a cover 20 and connected to the suction passage 12a. A contour 10b of the recessed portion 10a and a contour 20b of the recessed portion 20a substantially lie over or overlap inner peripheral ends 55b of the recessed portion 55 in the axial direction. Also, a contour 10c of the recessed portion 10a and a contour 20c of the recessed portion 20a substantially lie over or overlap inner peripheral ends 45b of the recessed portion 45. Thus, an area of each recessed portion 55 and 45 relative to the inlet port 12 reaches the maximum level and a larger amount of the fluid can flow into the interproximal spaces R via the recessed portions 45 and 55 from the inlet port 12, wherein the occurrence of cavitations is prevented.

FIG. 6 is a sectional view of a pump 200 mainly illustrating the connection between a driven rotor 240 and the driving rotor 250, and an inlet port 212. The recessed portions which have been described in this invention are not formed in the pump 200.

In this pump 200, it is not possible that large amount of the fluid flows into the approximate center of each interproximal space R smoothly. Accordingly, cavitation is likely to occur near the center of a tooth bottom portion located between external teeth of a driving rotor 250, which is indicated by diagonal lines in FIG. 6.

The operation according to the embodiment will be described as follows.

The pump 100 rotates with the driving rotor 50, which is rotated by a rotation driving force of the shaft 110, and the driven rotor 40 meshed. Therefore, the fluid is suctioned through the suction passage from the inlet port 12 and discharged to the discharged port 13 to be pumped to a receiving portion through the discharge passage 13a.

While the fluid is moved as described above, negative pressure is likely to occur in the interproximal space R defined between the driving rotor 50 and the driven rotor 40, specifically in the center of the interproximal space R. However, the driving rotor 50 is provided with the recessed portions 55 formed on the sides of each external tooth 51. Also, the driven rotor 40 is provided with the recessed portions 45 formed on the sides of each internal tooth 41. Therefore, the opening area of each interproximal space R can be expanded. In addition, it is possible to force the fluid into the approximate center of the interproximal space R by utilizing a centrifugal force so that the occurrence of cavitations is prevented.

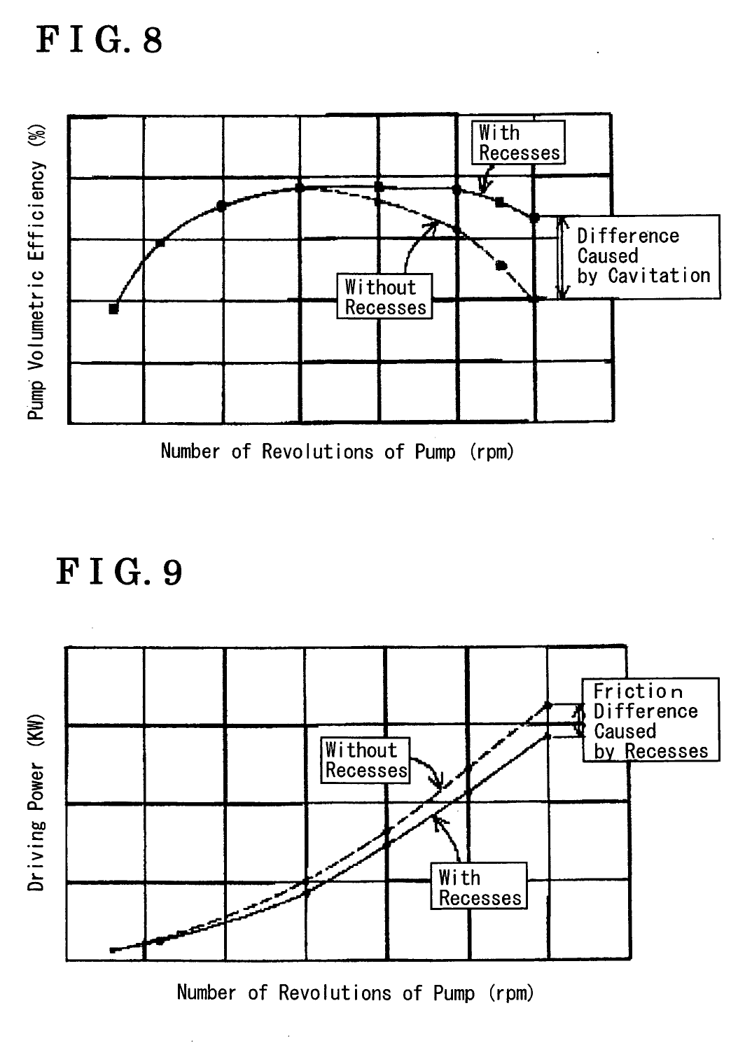

As illustrated in FIG. 8 and FIG. 9, in the pump 100 according to the embodiment of the present invention, high volumetric efficiency is achieved even at high revolutions. Moreover, reductions in sliding resistance and suction resistance are accomplished by forming the recessed portions 55 on the side faces of the driving rotor 50, so that a driving force is reduced.

Furthermore, each recessed portion 55 is formed at the outer side of a root diameter of the driving rotor 50 so that a sealing surface is assured between each recessed portion 55 and a center hole, into which the shaft 110 is fitted. Therefore, an external diameter of the driving rotor 50 is not increased. Also, each recessed portion 45 is formed at the inner side of a root diameter of the driven rotor 40 so that an external diameter of the driven rotor 40 is not increased. Thus, the enlargement of the pump 100 can be restrained.

In the pump 100 described above, each recessed portion 55 and 45 is formed in an L shape in a radially outward direction on the cross section including the-axis line of the driving rotor 50. As illustrated in FIG. 7, inclined recessed portions 550 may be formed inclining from the side faces of each tooth surface of the driving rotor 50, and inclined recessed portions 450 may be formed inclining from the side faces of each tooth surface of the driven rotor 40. In that case, the same effect is achieved and the fluid flows more smoothly.

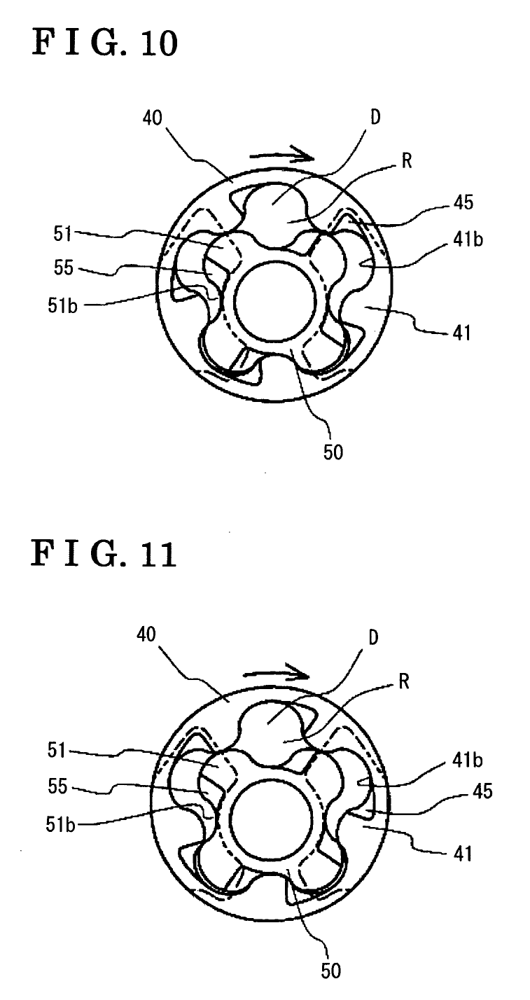

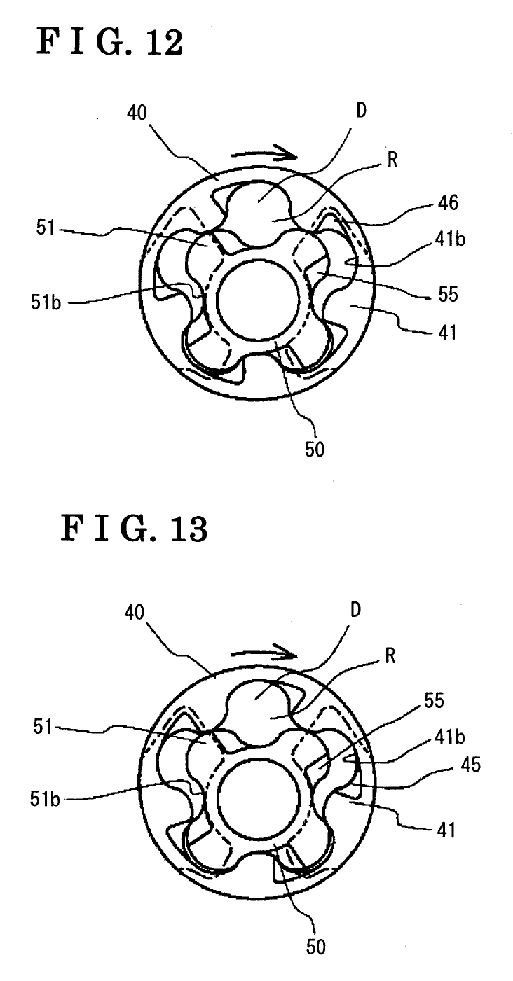

Further, in the pump 100 described above, each recessed portion 55 is formed on both sides of each tooth bottom portion 51b of the driving rotor 50, and each recessed portion 45 is formed on both sides of each tooth bottom portion 41b of the driven rotor 40. However, as illustrated in FIGS. 10-14, the same effect is achieved when the recessed portions 55 and 45 are formed on one side of each tooth bottom portion 51b, 41b.

Still further, in the pump 100 described above, the recessed portion is provided at both of the driving rotor 50 and the driven rotor 40. Alternatively, the recessed portion can be provided at at least one of the driving rotor 50 and the driven rotor 40.

In particular, in an example illustrated in FIG. 10, each recessed portion 55 of the drive rotor 50 opens in a reverse direction of the rotational direction of the driving rotor 50 and each recessed portion 45 of the driven rotor 40 opens in the rotational direction. Therefore, an area of the tooth which transmits a rotary force is not decreased. Consequently, antifriction effect is achieved without increasing contact pressure.

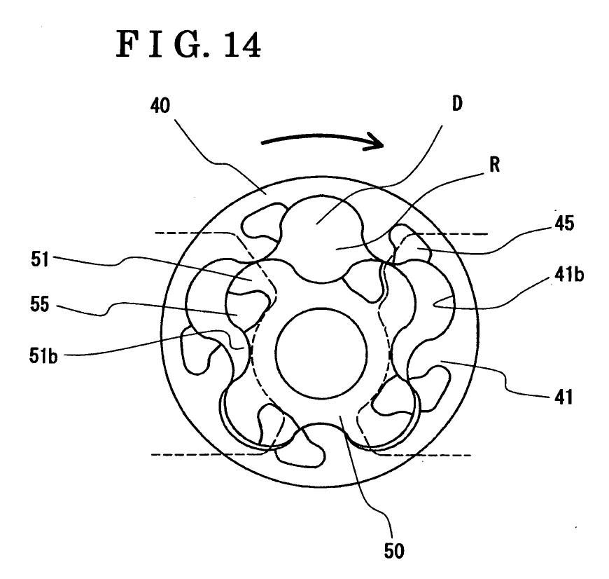

In FIG. 14, compared to FIG. 10, the recessed portions 45 and the recessed portions 55 are enlarged in the circumferential direction. By enlarging the recessed portions 45 and 55, the larger amount of the fluid can flow into the interproximal space R through the recessed portions 45 and 55 so that the occurrence of cavitations are prevented more effectively.

As described above, according to the present invention, a recessed portion is provided at at least one side surface of at least one of a driving rotor and a driven rotor and communicates with an inlet port and an interproximal space. The recessed portion is formed so as to prevent the inlet port and the outlet port from communicating with the interproximal space when the interproximal space is positioned to attain the maximum volume. The recessed portion opens in a direction between a radial direction of at least one of the driving rotor and the driven rotor and a circumferential direction thereof at the at least one side surface of each tooth of at least one of the driving rotor and the driven rotor. Therefore, an opening area of the interproximnal space towards a side surface of the rotors is enlarged and the intake flow of the fluid to the interproximal space is reduced.

Further, the recessed portion is formed at the outer side of the root diameter of the driving rotor, which restrains an increase in the outer diameter of the driving rotor,

Still father the recessed portion is formed at the inner side of the root diameter of the driven rotor, which restrains an increase in the outer diameter of the driven rotor

Still further, the recessed portion of at least one of the driving rotor and the driven rotor is formed in an L shape on the cross section including the axis of the driving rotor. Therefore, as for the driving rotor and the driven rotor, it is possible to make easier to form the recessed portion in a metal sintering process which is one of manufacturing methods generally employed.

Still further, the recessed portion is formed at the driving rotor to incline from the side surface of each tooth surface of the driving rotor, Therefore, the fluid can flow into the interproximal space smoothly. Still further, the recessed portion is formed at the driven rotor and inclines from the side surface of the driven rotor towards the tooth surface thereof. Therefore, the fluid flows into the interproximal space smoothly.

Still further, a circumferential edge of the recessed portion approximately lies over or overlaps a circumferential edge of a contour of either the outlet port 13 or the inlet port in an axial direction of the rotor. Therefore, the fluid can be suctioned from the inlet port and discharged to the outlet port in an efficient manner.

Still further, an opening area of the recessed portion as viewed from a side surface of the driving rotor is approximately identical to an opening area of the recessed portion as viewed from the side of the recessed portion in a direction perpendicular to an axial direction thereof. Therefore, the fluid of the recessed portion flows into the interproximal space smoothly.

Still further, the recessed portion is formed at the driving rotor and opens in a reverse direction as the rotation direction. Therefore, an area of the tooth surface which transmits a rotary force is not decreased. Consequently, antifriction effect is achieved without increasing contact pressure.

Still further, the recessed portion of the driven rotor opens in the same direction as the rotation direction. Therefore, an area of the tooth surface which receives a rotary force is not decreased. Consequently, antifriction effect is achieved without increasing contact pressure.

The principles of the preferred embodiment and mode of operation of the present invention have been described in the foregoing specification. However, the invention, which is intended to be protected, is not to be construed as limited to the particular embodiment disclosed. Further, the embodiment described herein are to be regarded as illustrative rather than restrictive, Variations and changes may be made by others, and equivalents employed, without departing from the spirit of the present invention. Accordingly, it is expressly intended that all such variations, changes and equivalents that fall within the spirit and scope of the present invention as defined in the claims, be embraced thereby.

1. An internal gear pump, comprising:
a housing forming a cylindrical space;
a driven rotor having internal teeth and rotatably disposed in the cylindrical space;
a driving rotor having external teeth engageable with the internal teeth and rotatably disposed in the driven rotor, the driving rotor and the driven rotor defining a plurality of interproximal spaces therebetween, the interproximal spaces repeatedly expanding and shrinking between the internal teeth of the driven rotor and the external teeth of the driving rotor engaged with the internal teeth so that fluid is suctioned and discharged;
an inlet port formed at the housing in communication with the cylindrical space;
an outlet port formed at the housing in communication with the cylindrical space;
a recessed portion provided at at least one side surface of at least one of the driven rotor and the driving rotor,
the recessed portion communicating with each corresponding interproximal space and defined in a way that the inlet port and the outlet port are prevented from communicating with each corresponding interproximal space at the position where each corresponding interproximal space attains the maximum volume, and the recessed portion opening in a direction between a radial direction of the one of the driving rotor and the driven rotor and a circumferential direction thereof at each tooth of the one of the driving rotor and the driven rotor.

2. An internal gear pump according to claim 1, wherein the recessed portion is formed at the outer side of a root diameter of the driving rotor.

3. An internal gear pump according to claim 1, wherein the recessed portion is formed at the inner side of a root diameter of the driven rotor.

4. An internal gear pump according to claim 1, wherein the recessed portion is formed in an L shaped figure on the cross section including the axis of the driving rotor.

5. An internal gear pump according to claim 1, wherein the recessed portion is formed at the driving rotor and inclines from a side face of the driving rotor to a tooth surface of the driving rotor.

6. An internal gear pump according to claim 1, wherein the recessed portion is formed at the driven rotor and inclines from a side face of the driven rotor to a tooth surface of the driven rotor.

7. An internal gear pump according to claim 1, wherein a circumferential edge of each recessed portion of the one of the driving rotor and the driven rotor lies over or overlaps a circumferential edge of a contour of one of the outlet port and the inlet port in an axial direction of the one of the driving rotor and the driven rotor.

8. An internal gear pump according to claim 1, wherein an opening area of the recessed portion as viewed from a side surface of the driving rotor is identical to an opening area of the recessed portion as viewed from the side of the recessed portion in a direction perpendicular to an axial direction thereof.

9. An internal gear pump according to claim 1, wherein the recessed portion is formed at the driving rotor and opens in a reverse direction of the rotation direction of the driving rotor.

10. An internal gear pump according to claim 1, wherein the recessed portion of the driven rotor opens in the same direction as a rotational direction of the driven rotor.
